(19) United States
(12) Patent Application Publication
(10) Pub. No.: US 2012/0098967 A1
(43) Pub. Date: Apr. 26, 2012

(54) 3D IMAGE MONITORING SYSTEM AND METHOD IMPLEMENTED BY PORTABLE ELECTRONIC DEVICE

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/052,128

(22) Filed: Mar. 21, 2011

(30) Foreign Application Priority Data
Oct. 25, 2010 (TW) 99136390

(51) Int. Cl. H04N 7/18

(52) U.S. Cl. 348/143; 348/E07.085

(57) ABSTRACT

A 3D image monitor system and method is implemented by an portable electronic device. The portable electronic device connects to one or more IP cameras located at a target place, and includes a 3D screen and a storage system. When the target place needs to be monitored, the system displays a 3D image of the target place on a touch screen of the portable electronic device according to 3D image data stored in the storage system. The system further generates a camera selection signal for selecting an IP camera when a location corresponding to the IP camera is touched, controls the IP camera to capture a series of scene images from the target place according to the camera selection signal, and displays the scene images of the target place on the touch screen for a user to inspect the situations of the target place.

### BACKGROUND

1. Technical Field

Embodiments of the present disclosure relate to image monitoring systems and methods, and particularly to a 3D image monitoring system and method implemented by a portable electronic device.

2. Description of Related Art

Image monitoring systems are widely used to monitor a target place, such as a road, a building, a supermarket, a bank, a factory, or any other place that needs to be monitored. One or more cameras may be installed in different locations of the target place to capture scene images of the different locations. However, a many monitoring systems do not display a 3D scene image of the target place on a monitor device connected to the system, and an observer cannot select the one or more cameras in the 3D scene image to monitor the target place. When the observer wants to inspect a location of the target place, he/she should memorize the number of a camera corresponding to the location to select the camera to capture digital images of the location. Accordingly, it is inconvenient for the observer to use the traditional monitoring system to monitor different locations of the target place.

### BRIEF DESCRIPTION OF THE DRAWINGS

FIG. 1 is a block diagram of one embodiment of a portable electronic device comprising a 3D image monitoring system.

FIG. 2 is a flowchart of one embodiment of a 3D image monitor method implementing the system of FIG. 1.

FIG. 3 is a schematic diagram illustrating one example of a 3D image of a target place to be monitored.

FIG. 4 is a schematic diagram illustrating one example of a user interface of the system of FIG. 1.

FIG. 5 is a schematic diagram illustrating one example of selecting an IP camera in the target place.

FIG. 6 is a schematic diagram illustrating one example of displaying scene images of the target place captured by the selected IP camera of FIG. 5.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

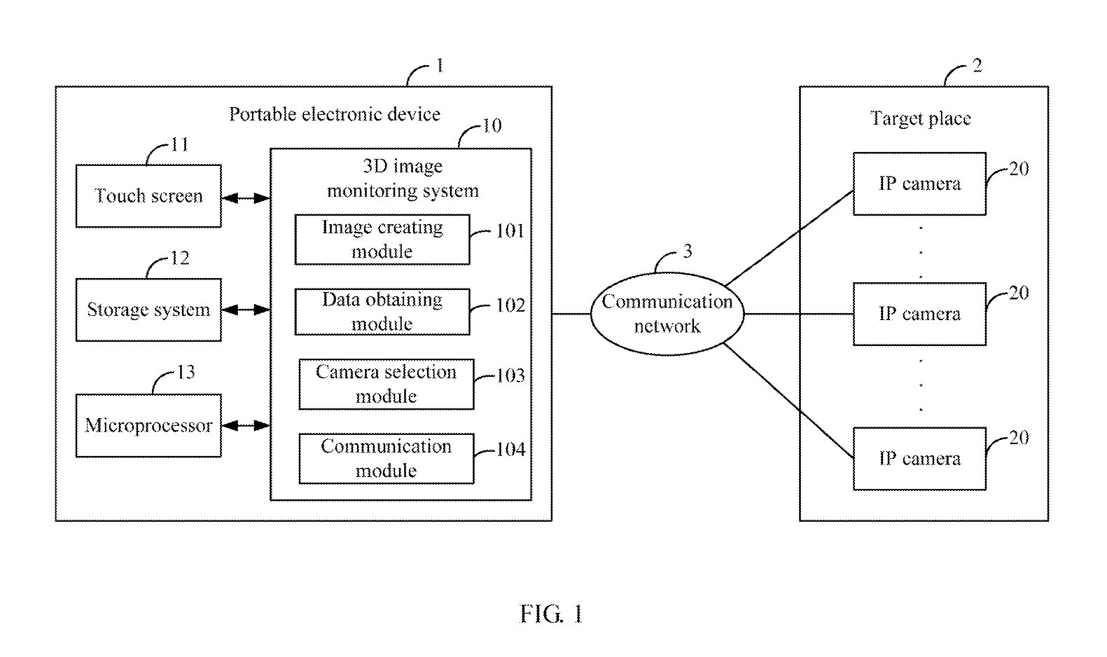

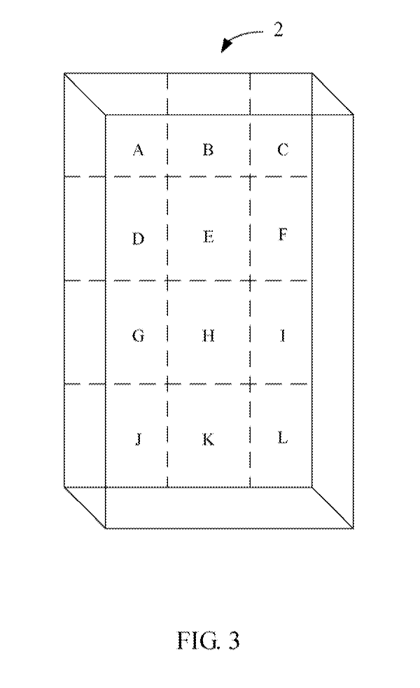

FIG. 1 is a block diagram of one embodiment of a portable electronic device 1 comprising a 3D image monitoring system 10. In the embodiment, the portable electronic device 1 may be a mobile phone, or a personal digital assistant (PDA), for example. The portable electronic device 1 connects to one or more Internet Protocol (IP) cameras 20 located at a target place 2 through a communication network 3, such as Internet, intranet, or any other suitable communication network system. The target place 2 may be a building, a supermarket, a bank, a factory, or any other place that needs to be monitored. Each of the IP cameras 20 is located at a location of the target place, and is used to capture scene images of the location monitored by the IP camera 20. In one example with respect to FIG. 3, each of the locations “A, B, C, D, E, F, G, H, I, J, K, L” of the target place 2 has an IP camera 20.

The portable electronic device 1 may include a touch screen 11, a storage system 12, and a least one microprocessor 13. The touch screen 11 is operable to display a 3D image of the target place 2, and scene images captured by the one or more IP cameras 20. The 3D image of the target place 2 is drawn using a 3D drawing program, such as a computer aided design (CAD) tool, and is stored in the storage system 12. In one embodiment, the storage system 12 may be an internal storage system, such as a random access memory (RAM) for temporary storage of information, and/or a read only memory (ROM) for permanent storage of information. In some embodiments, the storage system 12 may also be an external storage system, such as an external hard disk, a storage card, or a data storage medium.

In one embodiment, the 3D image monitoring system 10 includes an image creating module 101, a data obtaining module 102, a camera selection module 103, and a communication module 104. The modules 101-104 may comprise computerized code in the form of one or more programs that are stored in the storage system 12. The computerized code includes instructions that are executed by the at least one microprocessor 13 to provide functions for implementing the modules. In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage system.

The image creating module 101 is operable to create a 3D image of the target place 2 using a 3D drawing program, such as a computer aided design (CAD) tool. The image creating module 101 is further operable to set an IP address for each of the IP cameras 20 based on the 3D image of the target place to generate 3D image data, and store the 3D image data in the storage system 12. The 3D image data includes the 3D image of the target place, and the IP address of each of the IP cameras 20. In one example with respect to FIG. 3, an IP address of the IP camera 20 located at the location “E” in the target place is “252.95.6.8”.

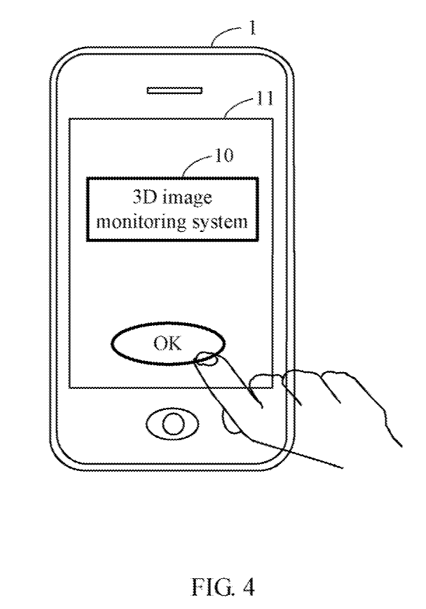

The data obtaining module 102 is operable to obtain the 3D image data from the storage system 12 when the target place 2 needs to be monitored, and display the 3D image of the target place 2 on the touch screen 11 according to the 3D image data. Referring to FIG. 4, the data obtaining module 102 displays the 3D image of the target place 2 on the touch screen 11 when an OK button displayed on the touch screen 11 is touched by a user.

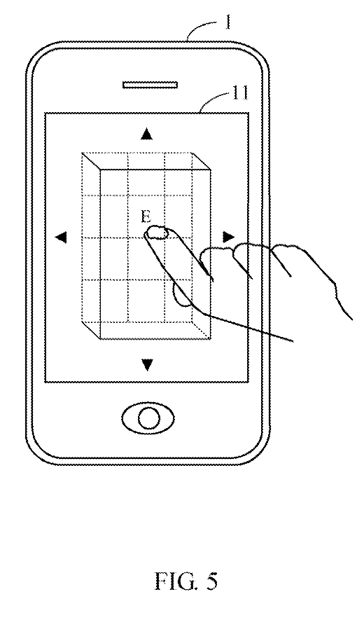

The camera selection module 103 is operable to adjust a display angle of the 3D image to present different locations of the target place 2 when the user touches the 3D image on the touch screen 11 in different directions, such as up, down, left or right directions. As such, the user can select one or more IP cameras 20 in the different locations of the target place 2. The camera selection module 103 is further operable to generate a camera selection signal for selecting an IP camera 20 when the user touches a location corresponding to the IP camera 20, such as the location “E” as shown in FIG. 5.

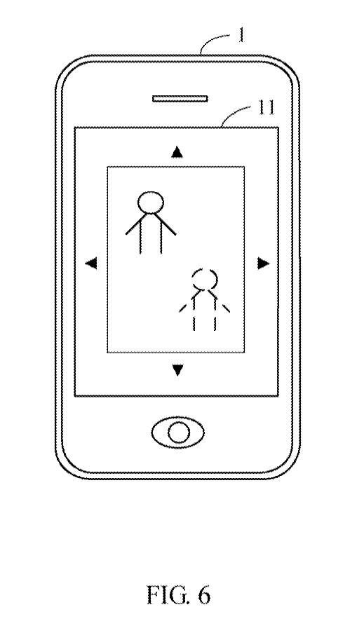

The communication module 104 is operable to transmit the camera selection signal to the corresponding IP camera 20 through the network communication 3, and control the IP camera 20 to capture a series of scene images from the corresponding location of the target place according to the camera selection signal. When the IP camera 20 receives the camera selection signal from the network communication 3, the IP camera 20 captures the scene images from the corresponding location of the target place. The communication module 104 is further operable to control the IP camera 20 to connect to the touch screen 11 according to the IP address of the IP camera 20, and display the scene images of the location of the target place 2 on the touch screen 11. In one example with respect to FIG. 6, a scene image of the location of the target place 2 is displayed on the touch screen 11, and the user can view the scene image of the location to inspect the situation of the target place 2.

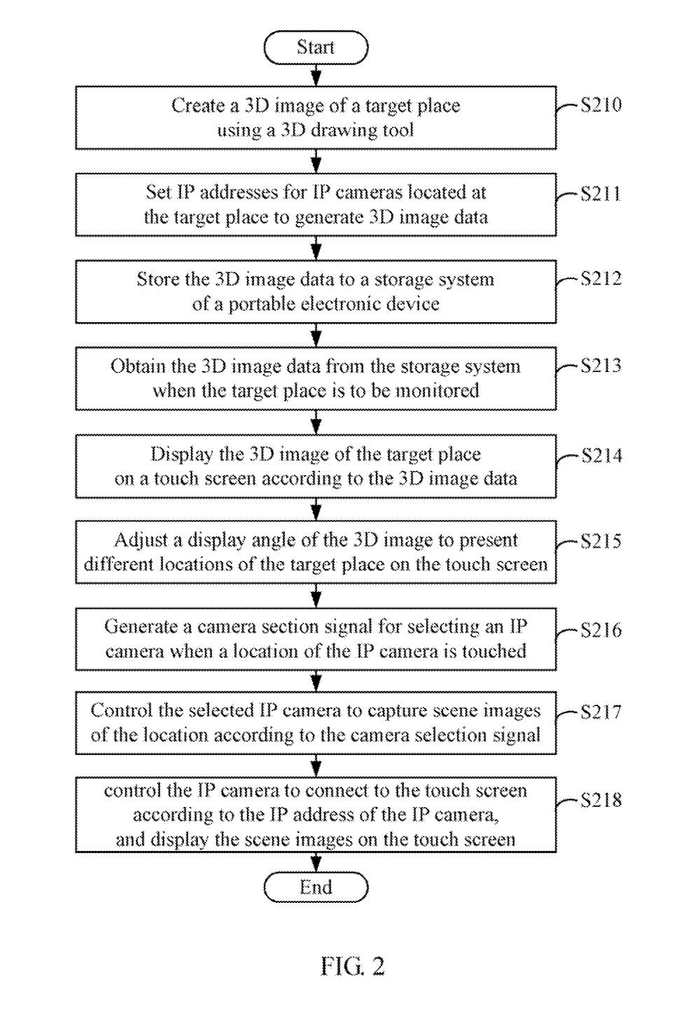

FIG. 2 is a flowchart of one embodiment of a 3D image monitor method implemented by the portable electronic device 1 of FIG. 1. Depending on the embodiment, additional blocks may be added, others removed, and the ordering of the blocks may be changed.

In block S210, the image creating module 101 creates a 3D image of the target place 2 using a 3D drawing program, such as a computer aided design (CAD) tool. In block S211, the image creating module 101 sets an IP address for each of the IP cameras 20 based on the 3D image of the target place to generate 3D image data. The 3D image data includes the 3D image of the target place, and the IP address of each of the IP cameras 20. In one example with respect to FIG. 3, the IP address of the IP camera 20 located at the location “E” is “252.95.6.8”. In block S212, the image creating module 101 stores the 3D image data in the storage system 12 of the portable electronic device 1.

In block S213, the data obtaining module 102 obtains the 3D image data from the storage system 12 when the target place 2 needs to be monitored. In block S214, the data obtaining module 102 displays the 3D image of the target place 2 on the touch screen 11 according to the 3D image data. Referring to FIG. 4, the data obtaining module 102 displays the 3D image of the target place 2 on the touch screen 11 when an OK button displayed on the touch screen 11 is touched by a user.

In block S215, the camera selection module 103 adjusts a display angle of the 3D image to present different locations of the target place 2 when the user touches the 3D image on the touch screen 11 in different directions, such as up, down, left or right directions. As such, the user can select one or more IP cameras 20 in the different locations of the target place 2. In block S216, the camera selection module 103 generates a camera selection signal for selecting an IP camera 20 when the user touches a location corresponding to the IP camera 20, such as the location “E” as shown in FIG. 5.

In block S217, the communication module 104 transmits the camera selection signal to the corresponding IP camera 20 through the network communication 3, and controls the IP camera 20 to capture a series of scene images from the corresponding location of the target place according to the camera selection signal. When the IP camera 20 receives the camera selection signal from the network communication 3, the IP camera 20 captures the scene images from the corresponding location of the target place.

In block S218, the communication module 104 controls the IP camera 20 to connect with the touch screen 11 according to the IP address of the IP camera 20, and displays the scene images of the location of the target place 2 on the touch screen 11. In one example with respect to FIG. 6, a scene image of the location of the target place 2 is displayed on the touch screen 11, and the user can view the scene image of the location to inspect the situation of the target place 2.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A portable electronic device, the portable electronic device electronically connected to one or more IP cameras located at a target place to be monitored, the device comprising:
a touch screen, a storage system, and at least one microprocessor; and
one or more programs stored in the storage system and executable by the at least one microprocessor, the one or more programs comprising:
an image creating module operable to create a 3D image of the target place using a 3D drawing tool, set an IP address for each of the IP cameras based on the 3D image of the target place to generate 3D image data, and store the 3D image data in the storage system;
a data obtaining module operable to display the 3D image of the target place on the touch screen according to the 3D image data;
a camera selection module operable to generate a camera selection signal for selecting an IP camera when a location of the target place corresponding to the IP camera is touched; and
a communication module operable to control the selected IP camera to capture a series of scene images from the location of the target place according to the camera selection signal, control the IP camera to connect to the touch screen according to the IP address of the IP camera, and display the scene images of the location of the target place on the touch screen.

2. The system according to claim 1, wherein the data obtaining module is further operable to obtain the 3D image data from the storage system when the target place needs to be monitored.

3. The system according to claim 1, wherein the camera selection module is further operable to adjust a display angle of the 3D image to present different locations of the target place before one of the IP cameras is selected.

4. The system according to claim 1, wherein each of the IP cameras is operable to capture the scene images from the location of the target place corresponding to the IP camera, and send the scene images to the portable electronic device through an communication network.

5. The system according to claim 1, wherein the 3D image data comprise the 3D image of the target place, and the IP address of each of the IP cameras.

6. A 3D image monitor method implemented by a portable electronic device, the portable electronic device electronically connected to one or more IP cameras located at a target place to be monitored, the method comprising:
creating a 3D image of the target place using a 3D drawing tool;
setting an IP address for each of the IP cameras based on the 3D image of the target place to generate 3D image data;
storing the 3D image data in a storage system of the portable electronic device;
displaying the 3D image of the target place on a touch screen of the portable electronic device according to the 3D image data;
generating a camera selection signal for selecting an IP camera when a location of the target place corresponding to the IP camera is touched;
controlling the selected IP camera to capture a series of scene images from the location of the target place according to the camera selection signal; and
controlling the IP camera to connect to the touch screen according to the IP address of the IP camera, and displaying the scene images of the location of the target place on the touch screen.

7. The method according to claim 6, further comprising:
obtaining the 3D image data from the storage system when the target place needs to be monitored.

8. The method according to claim 6, further comprising:
adjusting a display angle of the 3D image to present different locations of the target place selecting one of the IP cameras.

9. The method according to claim 6, wherein each of the IP cameras captures scene images from the location of the target place corresponding to the IP camera, and sends the scene images to the portable electronic device through an communication network.

10. The method according to claim 6, wherein the 3D image data comprise the 3D image of the target place, and the IP address of each of the IP cameras.

11. A non-transitory storage medium having stored thereon instructions that, when executed by at least one microprocessor of a portable electronic device that connects to one or more IP cameras located at a target place to be monitored, causes the portable electronic device to perform a 3D image monitor method, the method comprising:
creating a 3D image of the target place using a 3D drawing tool;
setting an IP address for each of the IP cameras based on the 3D image of the target place to generate 3D image data;
storing the 3D image data in a storage system of the portable electronic device;
displaying the 3D image of the target place on a touch screen of the portable electronic device according to the 3D image data;
generating a camera selection signal for selecting an IP camera when a location of the target place corresponding to the IP camera is touched;
controlling the selected IP camera to capture a series of scene images from the location of the target place according to the camera selection signal; and
controlling the IP camera to connect to the touch screen according to the IP address of the IP camera, and displaying the scene images of the location of the target place on the touch screen.

12. The storage medium according to claim 11, wherein the method further comprises:
obtaining the 3D image data from the storage system when the target place needs to be monitored.

13. The storage medium according to claim 11, wherein the method further comprises:
adjusting a display angle of the 3D image to present different locations of the target place before selecting one of the IP cameras.

14. The storage medium according to claim 11, wherein each of the IP cameras captures the scene images from the location of the target place corresponding to the IP camera, and sends the scene images to the portable electronic device through an communication network.

15. The storage medium according to claim 11, wherein the 3D image data comprise the 3D image of the target place, and the IP address of each of the IP cameras.
